(19) United States
(12) Patent Application Publication
(10) Pub. No.: US 2026/0201808 A1
(43) Pub. Date: Jul. 16, 2026

(54) DIFFUSED HOLES FOR INTER-SEGMENT PURGE AND METHOD

(71) Applicant: RTX Corporation, Farmington, CT (US)

(72) Inventors: Winston SMIDDY, South Windsor, CT (US); Howard LILES, Newington, CT (US); Alex SCHNEIDER, Manchester, CT (US)

(73) Assignee: RTX Corporation, Farmington, CT (US)

(21) Appl. No.: 19/024,226

(22) Filed: Jan. 16, 2025

(51) Int. Cl. F01D 11/24

(52) U.S. Cl. CPC F01D 11/08; F01D 9/04; F01D 25/24; F05D 2250/141; F05D 2250/71; F05D 2260/201; F05D 2260/202; F05D 2300/6033

(57) ABSTRACT

A ceramic matrix composite (CMC) component segment forming a portion of a substantially ring-shaped gas turbine engine stage includes a mateface extending axially between an upstream end and a downstream end of the CMC component and configured to form an inter-segment gap with an adjacent CMC component, and a plurality of film cooling holes having diffused openings at the mateface to provide film cooling of the mateface. A method of providing an inter-segment purge flow to such a CMC component includes disposing a first mateface of the CMC component segment next to a second mateface of an adjacent CMC component segment to form an inter-segment gap, and providing first film cooling of the first mateface via the plurality of film cooling holes having diffused openings at the first mateface.

### FIELD OF THE INVENTION

The subject matter disclosed herein relates to an inter-segment purge flow of a gas turbine component and, in particular, to provision of diffused holes for the inter-segment purge of ceramic matrix composite (CMC) components with film cooling flow.

### BACKGROUND OF THE INVENTION

Traditional blade outer air seal (BOAS) segments of gas turbine engines are often life-challenged at the edge where the primary gaspath surface and inter-segment mateface meet. This is due to the hot gaspath air becoming locally ingested or entrained in an inter-segment gap between adjacent matefaces, causing a localized hotspot. In Nickel superalloy designs, this can lead to local oxidation which may limit the life of the thermal barrier coating(s) (TBC), environmental barrier coating(s) (EBC), and/or substrate of the part.

BOAS cooling designs generally utilize inter-segment purge flow (e.g., via a dedicated circuit or by reusing air that has already been used to cool the part) in order to purge this volume created between BOAS segments and achieve acceptable durability for the given application. Most inter-segment purge takes the form of interlaced, impinging jets exchanged between one BOAS an adjacent BOAS. This cooling, while effective at purging the volume of gaspath air and minimizing the maximum temperature of the materials, creates high heat transfer coefficients due to the impingement cooling effect which, while not a concern for a Ni-alloy BOAS, can cause high stresses in a CMC BOAS due to thermal gradients based on the lower thermal conductivity of CMC materials.

The above information disclosed in this Background section is only for understanding of the background of the inventive concepts and, therefore, it may contain information that does not constitute prior art.

### SUMMARY OF THE INVENTION

The present disclosure is directed, in a first aspect, to a ceramic matrix composite (CMC) component segment forming a portion of a substantially ring-shaped gas turbine engine stage. The CMC component includes a mateface extending axially between an upstream end and a downstream end of the CMC component and configured to form an inter-segment gap with an adjacent CMC component, and a plurality of film cooling holes having diffused openings at the mateface to provide film cooling of the mateface.

In an embodiment of the CMC component, at least one circular non-diffused cooling hole and/or impingement cooling hole may also be disposed on the mateface.

In another embodiment of the CMC component, at least one of the plurality of film cooling holes may be a diffused slot.

In a further embodiment of the CMC component, the at least one diffused slot may be curved.

In yet another embodiment of the CMC component, at least one of the plurality of film cooling holes may be a “Vehr” hole having a diffuser surfaces not aligned with a meter of the film cooling hole.

In an embodiment of the CMC component, the plurality of film cooling holes may be substantially uniformly spaced on the mateface.

In another embodiment of the CMC component, the plurality of film cooling holes may be irregularly spaced on the mateface.

In a further embodiment of the CMC component, the plurality of film cooling holes may be angled relative to an axis of the engine.

In yet another embodiment, the CMC component may be a blade outer air seal (BOAS), a vane, a vane support, a blade platform, a blade shroud, or a combustion liner.

The present disclosure is also directed, in a second aspect, to a ceramic matrix composite (CMC) blade outer air seal (BOAS) segment forming a portion of a substantially ring-shaped BOAS stage. The CMC BOAS includes a mateface extending axially between a leading edge and a trailing edge of the CMC BOAS segment and configured to form an inter-segment gap with an adjacent CMC BOAS segment, and a plurality of film cooling holes having diffused openings at the mateface to provide film cooling of the mateface.

In an embodiment, CMC BOAS may also include at least one circular non-diffused cooling hole and/or impingement cooling hole disposed on the mateface.

In another embodiment of the CMC BOAS, the plurality of film cooling holes may include a hole with diffusion surfaces aligned with a meter of the film cooling hole, a “Vehr” hole having diffuser surfaces not aligned with a meter of the film cooling hole, a hole with a straight diffused slot, a hole with a curved diffused slot, or combinations thereof.

In a further embodiment of the CMC BOAS, at least one circular non-diffused cooling hole and/or impingement cooling hole may be disposed on the mateface.

The present disclosure is further directed, in a third aspect, to a method of providing an inter-segment purge flow to a ceramic matrix composite (CMC) component segment forming a portion of a substantially ring-shaped gas turbine engine stage. The method includes disposing a first mateface of the CMC component segment next to a second mateface of an adjacent CMC component segment to form an inter-segment gap, and providing first film cooling of the first mateface via a first plurality of film cooling holes having diffused openings at the first mateface.

In an embodiment, the method also may include purging the intersegment gap with airflow from the first film cooling.

In another embodiment, the method may include providing second film cooling of the second mateface via a second plurality of film cooling holes having diffused openings at the second mateface.

In a further embodiment, the method may include purging the intersegment gap with airflow from the first and second film cooling.

In yet another embodiment of the method, the first or the first and second plurality of film cooling holes may include a hole with diffusion surfaces aligned with a meter of the film cooling hole, a “Vehr” hole having diffuser surfaces not aligned with a meter of the film cooling hole, a hole with a straight diffused slot, a hole with a curved diffused slot, or combinations thereof.

In an embodiment of the method, the CMC component segment may be a blade outer air seal (BOAS) segment, a vane, a blade platform segment, or a combustion liner segment.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 schematically illustrates a partial cross section of an exemplary gas turbine engine;

FIG. 2 schematically illustrates a partial perspective view of an example embodiment of an inter-stage purge flow arrangement in accordance with the present disclosure;

FIG. 3 schematically illustrates a side view of an example embodiment of an inter-stage purge flow arrangement on a mateface in accordance with the present disclosure;

FIGS. 4A, 4B, and 4C schematically illustrate various examples of embodiments of diffused film cooling holes on a mateface for an inter-stage purge flow in accordance with the present disclosure;

FIG. 5 is a flow diagram of an example process in accordance with the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

As discussed in the Background above, when inter-segment purge takes the form of interlaced, impinging jets exchanged between one BOAS an adjacent BOAS, the resulting impingement cooling effect creates high heat transfer coefficients that can cause high stresses in a CMC BOAS.

Accordingly, embodiments in accordance with the present disclosure are configured to reduce or eliminate such impingement cooling by utilizing diffused cooling holes to protect the mateface with film cooling. The diffused cooling holes provide a more nuanced approach at protecting the CMC matefaces adjacent to the inter-segment gap volume in order to improve the thermal gradients at this location by reducing the heat transfer of purge cooling, while still minimizing the maximum material temperature caused by ingress of the hot gaspath flow.

While the illustrated examples and discussion below often make reference to a blade outer air seal (BOAS) and BOAS segments, it should be recognized that the concepts of the present disclosure are not limited to BOAS segments, but rather includes any CMC component with inter-segment gaps for which such inter-segment purge may also be useful. Accordingly, the present disclosure is not limited to inter-segment purge of CMC BOAS mateface gaps, but may also apply to inter-segment purge of other CMC components of a gas turbine engine such as vanes, vane supports, blade platforms, blade shrouds, combustion liners, and the like where it would be desirable to avoid high thermal stress of the CMC component due to impingement cooling.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces into the flow of the hot gases, i.e., faces upstream. The trailing edge/portion of a structure is the edge/portion that the faces away from the flow of the hot gases, i.e., faces downstream.

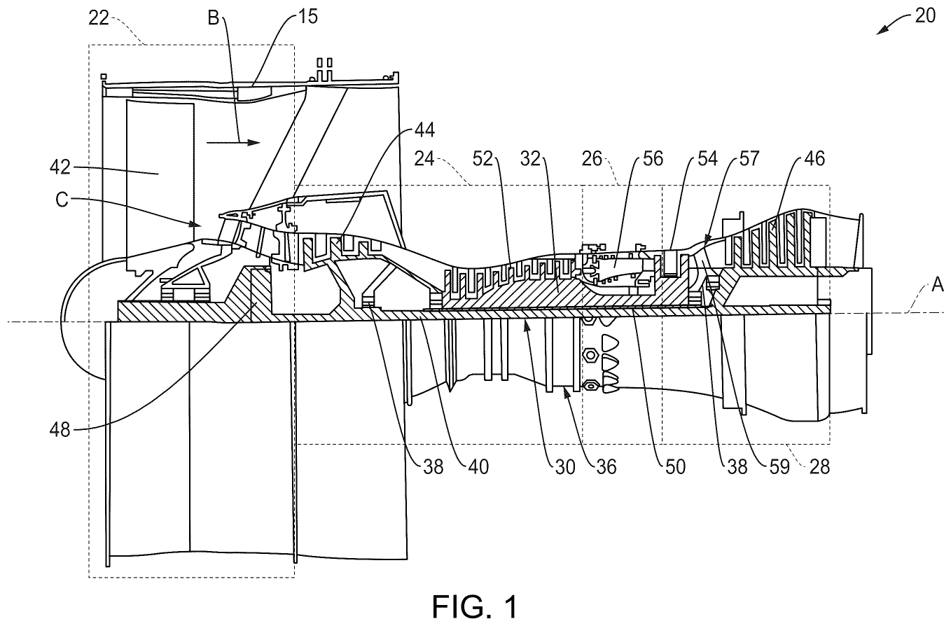

FIG. 1 schematically illustrates an example of a gas turbine engine 20 (i.e., a two-spool turbofan) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine engine, it should be understood that the concepts described herein are not limited to use with two-spool turbofans engines and may be applied to other types of turbine engines.

Engine 20 generally includes a low speed spool 30 and a high-speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

The turbine section 28 includes at least one rotor and at least one blade extending radially outwardly from the rotor. The turbine section 28 may further include a blade outer air seal(s) (BOAS(s)). The blade outer air seal can be an assembly of a plurality of BOAS segments that together form an annular shaped shroud around the engine's central longitudinal axis A which is positioned between an outer casing of the engine and the turbine blade(s) of the turbine section.

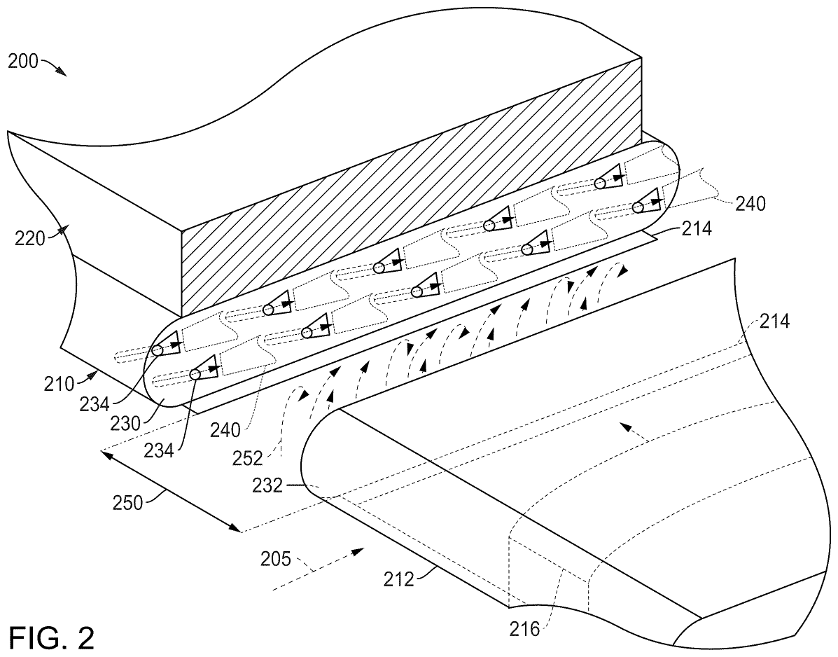

With reference to FIG. 2, an embodiment of the present disclosure is illustrated with respect to a leading edge portion of a ceramic matrix composite (CMC) BOAS 200. A first CMC BOAS segment 210 may be adjacent a second CMC BOAS segment 212, and the CMC BOAS segments 210 and 212 of CMC BOAS 200 may include a seal 220 (e.g., a brush seal or the like) to an upstream component, illustrated herein in cut-away form for clarity. CMC BOAS segments 210 and 212 thus form a portion of a substantially ring-shaped BOAS stage of a gas turbine engine, however, embodiments are not limited thereto and the CMC component in other embodiments may take other forms, including but not limited to a vane, a vane support, a blade platform, a blade shroud, and a combustion liner.

CMC BOAS segment 210 includes a first mateface 230 extending axially between an upstream end (e.g., a leading edge) and a downstream end (e.g., a trailing edge) of the CMC BOAS segment 210. In a similar manner, adjacent CMC BOAS segment 212 includes a second mateface 232 with is obscured from view. Each of CMC BOAS segments 210 and 212 may also include a ceramic barrier coating 214 which may serve a variety of functions, including resisting heat transfer into the component, chemically protecting the CMC substrate from oxidative processes, and/or providing an abradable layer to form a seal with a turbine blade tip 216. A side edge of the ceramic barrier coatings 214 may form a portion of the first and second matefaces 230 and 232.

The first and second matefaces 230 and 232 are configured to form (i.e., define) an inter-segment gap 250 between the first and second CMC BOAS segments 210 and 212, which is shown in an exaggerated scale for clarity. The engine 20 includes a primary gaspath 205 flowing axially within the engine that is hot and may heat the CMC BOAS 200 to high temperatures. A portion of gaspath air 252 may flow into inter-segment gap 250 and heat the first and second matefaces 230 and 232.

In accordance with an embodiment of the present disclosure, the portion of gaspath air 252 that may leak into inter-segment gap 250 may be purged with medium temperature, medium pressure film cooling airflow from a plurality of film cooling holes 234 having diffused openings at the mateface 230 to provide film cooling of the mateface 230 with cooling film 240.

While it is possible that the film cooling holes 234 at the mateface 230 can provide sufficient cooling and purge air for the first and second matefaces 230 and 232 of the inter-segment gap 250, in one or more embodiments, the (obscured) second mateface 232 of adjacent CMC BOAS segment 212 may also include film cooling holes 234 having diffused openings at the mateface 232 to provide film cooling of the mateface 232 with cooling film 240, with the additional film cooling airflow also providing purge flow to the inter-segment gap 250.

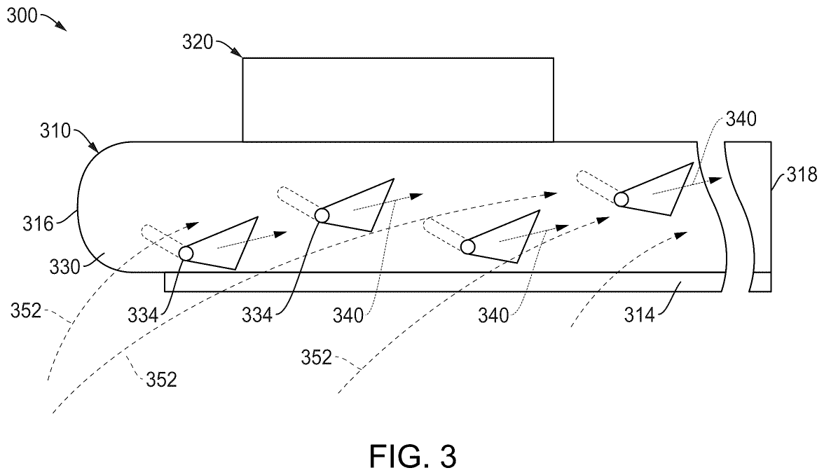

FIG. 3 illustrates a side view of a CMC component segment in accordance with the present disclosure, in this case a portion 300 of CMC BOAS segment 310. CMC BOAS segment 310 includes a mateface 330 extending axially between a leading edge 316 and a trailing edge 318 of the CMC BOAS segment 310. The CMC BOAS segment 310 is also configured to form an inter-segment gap with an adjacent CMC BOAS segment, as illustrated in FIG. 2.

Similar to FIG. 2, the CMC BOAS segment 310 of FIG. 3 may also have an adjacent seal 320 and include a ceramic barrier coating 314 that may form a portion of the mateface 330. The mateface 330 forms or defines the inter-segment gap into which a portion of gaspath air 352 may flow into to cause heating of mateface 330. In accordance with an embodiment of the present disclosure, the portion of gaspath air 352 that may leak into the inter-segment gap may be purged with medium temperature, medium pressure film cooling airflow from a plurality of film cooling holes 334 having diffused openings at the mateface 330 to provide film cooling of the mateface 330 with cooling film 340. In this manner, the temperature of mateface 330 may be controlled without the overcooling that may result from impingement cooling an inter-segment mateface so as to control thermal stress in the CMC BOAS segment 310 and purge the inter-segment gap.

In accordance with the present disclosure, at least some of the film cooling holes in the mateface(s) should have disused openings at their outlets. However, the size, type, arrangement, and spacing of the film cooling holes are not limited and may take many different forms.

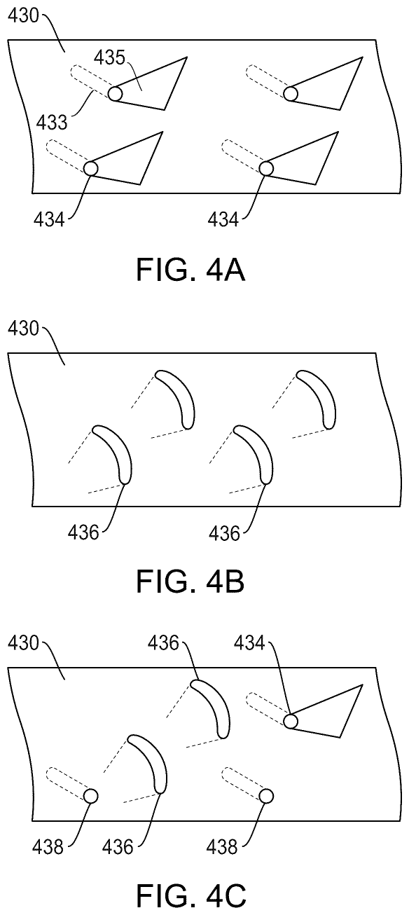

For example, FIG. 4A illustrates an embodiment of a CMC component segment mateface 430 in which the plurality of film cooling holes 434 are “Vehr” holes that each have diffuser surfaces that are not aligned with a meter of the film cooling hole 434. Such “Vehr” holes may vary in size and/or distribution, such as being evenly-spaced or irregularly-spaced to provide a desired cooling profile.

FIG. 4B illustrates another embodiment of a CMC component segment mateface 430 in which the plurality of film cooling holes 436 have fan-shaped, diffused slots. The diffused slot portions of film cooling holes 436 may be straight or may be curved, and are shown as curved in FIG. 4B. Such slot-shaped holes may vary in size, curvature, and/or distribution, such as being evenly-spaced or irregularly-spaced or using a combination of straight and curved slots to provide a desired cooling profile.

FIG. 4C illustrates a further embodiment of a CMC component segment mateface 430 in which the plurality of film cooling holes 434, 436, and/or 438 are used in mixed combinations of slotted straight/curved diffused holes 436, straight/Vehr diffused holes 434, and circular holes 438, that may be non-diffused film cooling holes and/or impingement cooling holes that may, for example, be desirable to use at the hottest portions of the mateface 430.

Thus, in accordance with the present disclosure, the plurality of film cooling holes 434 and 436 may include a hole with diffusion surfaces aligned with a meter of the film cooling hole, a “Vehr” hole having diffuser surfaces not aligned with a meter of the film cooling hole, a hole with a straight diffused slot, a hole with a curved diffused slot, and combinations thereof.

Additionally, in any of the embodiments of FIGS. 2, 3, 4A, 4B, or 4C, it may be desirable to have the diffusion portions of the plurality of film cooling holes 234, 334, 434, 436, or the meter of holes 438 arranged to be angled relative to an axis of the engine so as to align more closely with the gaspath air 252, 352 to assist in the formation and profile of the cooling film 240, 340.

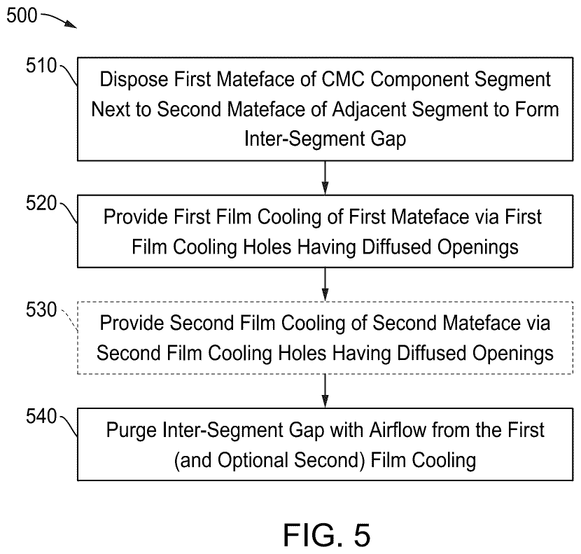

One or more embodiments of the present disclosure are also directed to method 500 of providing an inter-segment purge flow to a CMC component segment forming a portion of a substantially ring-shaped gas turbine engine stage as illustrated in the flow diagram of FIG. 5.

The method 500 includes, in a first step 510, disposing a first mateface of the CMC component segment next to a second mateface of an adjacent CMC component segment to form an inter-segment gap. In one or more embodiments of the method 500, the CMC component segments may include a blade outer air seal (BOAS) segment, a vane, a vane support segment, a blade platform segment, a blade shroud segment, or a combustion liner segment.

The method 500 further includes a next step 520 of providing first film cooling of the first mateface via a first plurality of film cooling holes having diffused openings at the first mateface. In various embodiments, the first film cooling may be provided by the first plurality of film cooling holes using holes that include at least one of a hole with diffusion surfaces aligned with a meter of the film cooling hole, a “Vehr” hole having diffuser surfaces not aligned with a meter of the film cooling hole, a hole with a straight diffused slot, a hole with a curved diffused slot, and/or combinations thereof.

Optionally, method 500 may also include a step 530 of providing second film cooling of the second mateface via a second plurality of film cooling holes having diffused openings at the second mateface. As with step 520, in various embodiments, the second film cooling may be provided by the second plurality of film cooling holes using holes that include at least one of a hole with diffusion surfaces aligned with a meter of the film cooling hole, a “Vehr” hole having diffuser surfaces not aligned with a meter of the film cooling hole, a hole with a straight diffused slot, a hole with a curved diffused slot, and/or combinations thereof.

Method 500 further includes a step 540 of purging the intersegment gap with airflow from the first film cooling. In various embodiments, the step 540 may optionally include purging the intersegment gap with airflow from the first and second film cooling when second film cooling is provided at the second mateface.

By using diffused and/or shaped holes to lay a cooling film onto the surface of the mateface in accordance with the present disclosure, the cooling flow can be mixed with gaspath air to create an intermediate-temperature mixture which will characteristically benefit thermal gradients and stresses within the CMC components. Indeed, embodiments of the present disclosure may avoid the high heat transfer coefficients commonly associated with typical interlaced impingement layouts, which will also characteristically benefit thermal gradients and stresses within the CMC components.

In accordance with the present disclosure, the entire volume of the inter-segment gap may not need to be purged, thus reducing minimum dedicated purge flow requirements and allowing the minimum (often transient) inter-segment gap size to be further reduced, both of which can benefit the thermodynamic efficiency of the turbine.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A ceramic matrix composite (CMC) component forming a portion of a substantially ring-shaped gas turbine engine stage, the CMC component comprising:
a mateface extending axially between an upstream end and a downstream end of the CMC component and configured to form an inter-segment gap with an adjacent CMC component; and
a plurality of film cooling holes arranged in a plurality of rows and having constant diameter meters and diffused openings at the mateface configured to provide film cooling of the mateface.

2. The CMC component of claim 1, further comprising at least one circular non-diffused cooling hole and/or impingement cooling hole disposed on the mateface.

3. The CMC component of claim 1, wherein at least one of the plurality of film cooling holes is a diffused slot.

4. The CMC component of claim 3, wherein at least one diffused slot is curved.

5. The CMC component of claim 1, wherein at least one of the plurality of film cooling holes is a “Vehr” hole having a diffuser surface not aligned with the meter of the respective film cooling hole.

6. The CMC component of claim 1, wherein the plurality of film cooling holes is substantially uniformly spaced on the mateface.

7. The CMC component of claim 1, wherein the plurality of film cooling holes is irregularly spaced on the mateface.

8. The CMC component of claim 1, wherein the plurality of film cooling holes is angled relative to an axis of the engine.

9. (canceled)

10. A ceramic matrix composite (CMC) blade outer air seal (BOAS) segment forming a portion of a substantially ring-shaped BOAS stage, the CMC BOAS segment comprising:
a mateface extending axially between a leading edge and a trailing edge of the CMC BOAS segment and configured to form an inter-segment gap with an adjacent CMC BOAS segment; and
a plurality of film cooling holes arranged in a plurality of rows and having constant diameter meters and diffused openings at the mateface configured to provide film cooling of the mateface.

11. The CMC BOAS segment of claim 10, further comprising at least one circular non-diffused cooling hole and/or impingement cooling hole disposed on the mateface.

12. The CMC BOAS segment of claim 10, wherein the plurality of film cooling holes include a hole with a diffuser surface aligned with the meter of the respective film cooling hole, a “Vehr” hole having a diffuser surface not aligned with the meter of the respective film cooling hole, a hole with a straight diffused slot, a hole with a curved diffused slot, or combinations thereof.

13. The CMC BOAS segment of claim 12, further comprising at least one circular non-diffused cooling hole and/or impingement cooling hole disposed on the mateface.

14. A method of providing an inter-segment purge flow to a ceramic matrix composite (CMC) component segment forming a portion of a substantially ring-shaped gas turbine engine stage, the method comprising:
disposing a first mateface of the CMC component segment next to a second mateface of an adjacent CMC component segment to form an inter-segment gap; and
providing first film cooling of the first mateface via a first plurality of film cooling holes arranged in a plurality of rows and having constant diameter meters and diffused openings at the first mateface.

15. The method of claim 14, further comprising purging the intersegment gap with airflow from the first film cooling hole.

16. The method of claim 14, further comprising providing second film cooling of the second mateface via a second plurality of film cooling holes having diffused openings at the second mateface.

17. The method of claim 16, further comprising purging the intersegment gap with airflow from the first and second film cooling holes.

18. The method of claim 17, wherein the first and second plurality of film cooling holes include a hole with a diffuser surface aligned with the meter of the respective film cooling hole, a “Vehr” hole having a diffuser surface not aligned with the meter of the respective film cooling hole, a hole with a straight diffused slot, a hole with a curved diffused slot, or combinations thereof.

19. The method of claim 14, wherein the first plurality of film cooling holes include a hole with a diffuser surface aligned with the meter of the respective film cooling hole, a “Vehr” hole having a diffuser surface not aligned with the meter of the respective film cooling hole, a hole with a straight diffused slot, a hole with a curved diffused slot, or combinations thereof.

20. (canceled)
